(19) United States
(12) Patent Application Publication
(10) Pub. No.: US 2019/0301637 A1
(43) Pub. Date: Oct. 3, 2019

(54) Valve And Method For Production Of A Valve

(71) Applicant: GEMUE Gebr. Mueller Apparatebau GmbH & Co. Kommanditgesellschaft, Ingelfingen (DE)

(72) Inventors: Thomas Volpp, Moeckmuehl (DE); Matthias Fick, Kuenzelsau (DE); Philipp Ziegler, Limbach (DE)

(73) Assignee: GEMUE Gebr. Mueller Apparatebau GmbH & Co. Kommanditgesellschaft, Ingelfingen (DE)

(21) Appl. No.: 16/468,314

(22) PCT Filed: Dec. 14, 2017
(86) PCT No.: PCT/EP2017/082862

§ 371 Date: Jun. 11, 2019

(30) Foreign Application Priority Data
Dec. 21, 2016 (DE) 10 2016 125 114.3

(51) Int. Cl. F16K 37/00; F16K 7/12

(52) U.S. Cl. CPC F16K 37/0025; G06K 19/041; F16K 7/126

(57) ABSTRACT

A valve, in particular a diaphragm valve, is proposed, in which a transponder is arranged in a transponder frame. An outer opening of the transponder frame is closed with a sealing compound. The transponder frame is connected to an outer surface of a component of the valve.

### CROSS-REFERENCE TO RELATED APPLICATIONS

This is a National Stage Application, filed under 35 U.S.C. 371, of International Patent Application No. PCT/EP2017/082862, filed on Dec. 14, 2017, which claims priority to German Application No. DE 10 2016 125 114.3, filed Dec. 21, 2016, the entire contents of each of which are incorporated herein by reference in their entirety.

### BACKGROUND

The invention relates to a valve described herein and a method for producing a valve as described herein.

Diaphragm valves are generally known to provide a process fluid by means of a diaphragm which interacts with a valve seat. Diaphragm valves are frequently exposed to harsh environmental conditions. For example, in certain sectors, such as the food industry, it is necessary to regularly clean the surfaces of the diaphragm valve.

Furthermore, transponders, in particular RFID transponders, which can be read out contactlessly by means of a reading device, are known. These can be designed, for example, as a sticker. These RFID transponders can have an individual identifier which can be read out contactlessly.

Therefore, the problem addressed by the invention is that of providing a valve or a method for producing the valve, which, in a favorable manner, allows for a permanent identification of the valve or a component of the valve.

### SUMMARY OF THE INVENTION

The problem addressed by the invention is solved by a valve described herein and by a method for producing the valve as described herein.

A valve is proposed, in which a transponder is arranged in a transponder frame. An outer opening of the transponder frame is closed with a sealing compound. The transponder frame is connected to an outer surface of a component of the valve.

As a result, a transponder is advantageously arranged on a component in a sterilizable and cleanable manner. In addition, there are advantages for the user of the valve because over the entire life cycle of the valve, a unique assignment of the component is ensured. For example, it can be determined which components were shipped jointly. A tracing of the components of the valve is thus made possible.

In an advantageous embodiment, the component is a drive housing and/or a valve body and/or a type plate connectable to the drive housing or the valve body.

In an advantageous embodiment, the transponder frame, in the direction of the component, has a planar contact surface for connecting to the planar surface of the component. Due to the planar design of both the contact surface and the surface of the component, the transponder frame can be used for a multiplicity of differently designed valves and components.

In an advantageous embodiment, the transponder frame tapers in the direction of the outer opening. This improves the cleanability of the entire valve. At the same time, a sufficiently large surface is available for connecting to the surface of the component.

The further aspect relates to the method for producing a valve. The method comprises: arranging a transponder in a transponder frame; closing an outer opening of the transponder frame with a sealing compound; and connecting the transponder frame to an outer surface of a component of the valve.

In an advantageous embodiment, the transponder is introduced into the transponder frame via an introduction opening located opposite of the outer opening. As a result, the outer opening can be used for a closing with the sealing compound, and the attachment of the transponder is decoupled from the closing of the outer opening.

In an advantageous embodiment, the connection of the transponder frame to the component of the valve is produced by a laser welding process. As a result, a fluid-tight and material-locking connection between the transponder frame and the surface of the component is made possible in a secure manner.

Further advantageous features and embodiments can be found in the following description of the drawing. The same reference signs shall to some extent be used even in the case of different embodiments, without reference being made explicitly thereto.

### BRIEF DESCRIPTION OF THE DRAWINGS

The drawing shows in:

FIG. 1 a schematic cross section of a valve;

FIG. 2 a schematic perspective view of a transponder unit;

FIGS. 3-6 different sectional views of a module frame or the transponder unit; and

FIG. 7 a schematic flowchart.

### DETAILED DESCRIPTION

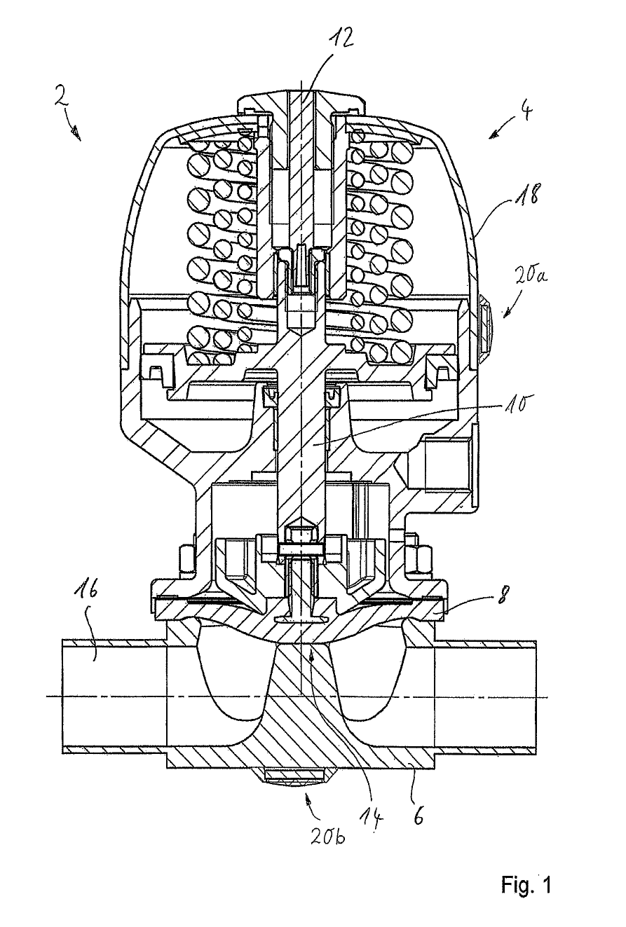

FIG. 1 shows a schematic cross section of an exemplary valve 2 which is designed as a diaphragm valve. A diaphragm 8 is arranged between a drive 4 and a valve body 6. The diaphragm 8 is moved by means of a valve spindle 10 along an infeed axis 12 and closes and opens a fluid channel 16 of the valve body 6 through interaction with a valve seat 14. A transponder unit 20a is arranged on a drive housing 18. A transponder unit 20b is arranged on the valve body 6.

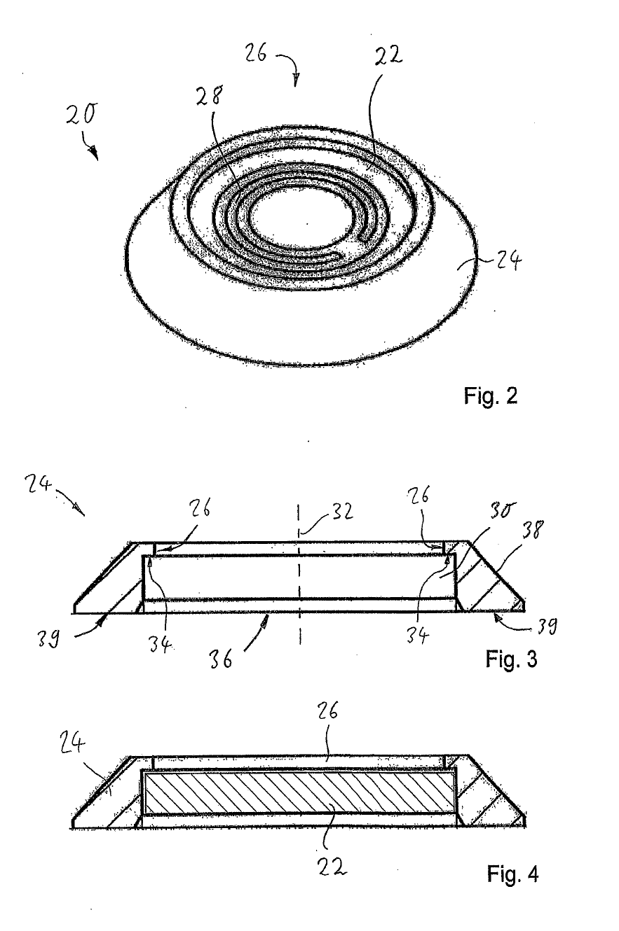

FIG. 2 shows a schematic perspective view of the transponder unit 20. The transponder unit 20 comprises a transponder 22 and a transponder frame 24 which surrounds the transponder 22 in sections. The transponder frame 24 is made of a metal alloy. The transponder frame 24 comprises an outer opening 26, which, in a built-in state, is closed with a sealing compound. The sealing compound is not shown in FIG. 2. Instead, FIG. 2 shows that a coupling structure 28 of the transponder 22 is arranged to be oriented in the direction of the outer opening 26. Via the coupling structure 26, the wireless communication takes place.

The transponder 22, for example, is an RFID transponder and complies with at least one of the standards ISO 15693, ISO 14443, ISO 18000-6c. Furthermore, the transponder 22 is designed to be disc-shaped and round in circumferential direction.

FIG. 3 shows the transponder frame 24 in a schematic sectional view. The transponder frame 24 is designed to be essentially rotationally symmetrical about an axis of rotation 32 and has a receiving space 30 for receiving the transponder 22. The outer opening 26, facing outward from a surface of a component, has a smaller diameter than the receiving space 30. In the direction of the outer opening 26, the receiving space 30 is delimited by an annular stop area 34. The stop area 34 limits a movement of the transponder 22 in the direction of the opening 26. Facing away from the outer opening 26, the transponder frame 24 comprises an introduction opening 36 for introducing the transponder 22. A diameter of the receiving space 30 transverse to the axis of rotation 32 is adjusted to the outer diameter of the transponder 22 such that the transponder 22 is held in the transponder frame 24 by a press fit. By means of the stop area 34, an anti-loss arrangement of the transponder 22 in the transponder frame 24 is additionally created. An outer surface 38 of the transponder frame 24 is designed to be frusto-conical, wherein the transponder frame 24 tapers in the direction of the outer opening 26 for better cleanability. Furthermore, the transponder frame 24 comprises a contact surface 39, which is essentially designed to be annular. The contact surface 39 is used for bearing against and material-lockingly connecting to the surface of the component of the valve 2. In one embodiment, the contact surface 39 can be arranged in a plane with a surface of the transponder 22 such that the transponder 22 also bears against the surface of the component.

FIG. 4 shows a schematic sectional view of the transponder 22 arranged in the transponder frame 24.

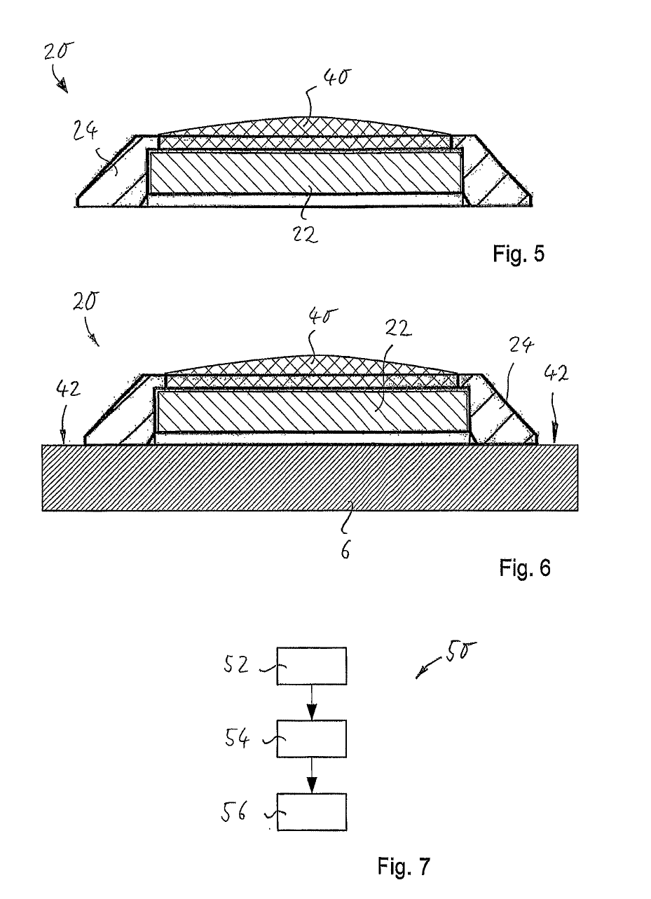

FIG. 5 shows a schematic sectional view of the transponder unit 20. In contrast to FIG. 4, the sealing compound 40 is introduced into the outer opening 26. The sealing compound 40 comprises, for example, epoxy resin which is first metered into the opening 26. The metered sealing compound 40 is subsequently cured during a curing time of at least 10 minutes, in particular at least 15 minutes, in an oven at an evaluation temperature above 100° C., in particular above 130° C. In a further embodiment, the transponder unit 20 is cured in the oven at 150° for one hour. As a result, the outer opening 26 is closed in a fluid-tight manner with the sealing compound 40. At the same time, the sealing compound 40 is not electrically conductive and not magnetizable; as a result, the transponder 22 can be addressed wirelessly through the sealing compound 40.

FIG. 6 shows a schematic sectional view of the transponder unit 20 which is arranged on and connected to the surface 42 in a material-locking manner. Preferably, the transponder frame 24 is material-lockingly connected to the planar surface 42 of the component of the valve 2 by a laser welding process. The component, for example, can be the valve body 6 shown in FIG. 1, the drive housing 18, or a type plate which can be arranged on these components. The component, on which the transponder unit 20 is arranged, is made of a metal alloy.

FIG. 7 shows a schematic flowchart 50. In a first step 52, the transponder 22 is arranged in the transponder frame 24. The transponder 22 and the transponder frame 24 are initially freed from contamination, and then the transponder 22 is pressed into the transponder frame 24 by means of a press-fit device.

In a second step 54, the outer opening 26 of the transponder frame 24 is closed with the sealing compound 40. For this purpose, a metering device introduces a quantity of the still liquid sealing compound 40 into the outer opening 26. The quantity of the liquid sealing compound 40 is measured such that a convex surface is formed which is flush with the edge of the outer opening 26. In addition, it is possible to guide hot air to the introduced sealing compound 40 in order to prevent air bubbles. Step 54 further comprises the curing of the sealing compound 40 in the oven. Step 54 is completed with an optical inspection for defects in the sealing compound 40.

In a third step 56, the transponder frame 24 is subsequently connected to a component of the valve 2. By means of a laser welding device, a laser welding process is used to arrange the transponder frame 24 on the surface 42 in a material-locking and fluid-tight manner.

1. Valve, comprising:
a component having an outer surface;
a transponder arranged in a transponder frame having an outer opening;
the outer opening of the transponder frame is closed with a sealing compound; and
the transponder frame is connected to the outer surface of the component of the valve.

2. Valve according to claim 1, wherein the component is one of a drive housing and a valve body (6) and a type plate connectable to one of the drive housing or the valve body.

3. Valve according to claim 1, wherein the transponder frame, in the direction of the component, has a planar contact surface for connecting to the planar surface of the component.

4. Valve according to claim 1, wherein the transponder frame tapers in the direction of the outer opening.

5. Method for producing a valve characterized by the following steps:
arranging a transponder in a transponder frame;
closing an outer opening of the transponder frame with a sealing compound; and
connecting the transponder frame to an outer surface of a component of the valve.

6. Method according to claim 5, wherein the transponder is introduced into the transponder frame via an introduction opening located opposite of the outer opening.

7. Method according to claim 5, wherein the connection of the transponder frame to the component of the valve is produced by a laser welding process.

8. A manufacturing system for producing a valve, comprising:
a. producing a valve characterized by the following steps:
b. means for arranging a transponder in a transponder frame;
c. means for closing an outer opening of the transponder frame with a sealing compound; and
d. means for connecting the transponder frame to an outer surface of a component of the valve, wherein the transponder is introduced into the transponder frame via an introduction opening located opposite of the outer opening, and the connection of the transponder frame to the component of the valve is produced by a laser welding process.
